(19) United States
(12) Patent Application Publication
(10) Pub. No.: US 2026/0315975 A1
(43) Pub. Date: Oct. 15, 2026

(54) FILTER ELEMENT, SEPARATING ELEMENT AND SEPARATING DEVICE

(71) Applicant: MANN+HUMMEL GmbH, Ludwigsburg (DE)

(72) Inventors: Klemens DWORATZEK, Edingen (DE); Kai HILARIUS, Dudenhofen (DE); Mohan BANGALORE PANNEERSELVAM, Frankfurt (DE)

(21) Appl. No.: 19/685,390

(22) Filed: May 22, 2026

Related U.S. Application Data
(63) Continuation of application No. PCT/EP2024/082659, filed on Nov. 18, 2024.

(30) Foreign Application Priority Data
Nov. 24, 2023 (DE) 10 2023 132 841.7

(51) Int. Cl. B01D 46/00; B01D 45/08; B01D 46/24; B01D 46/58; B01D 50/20

(52) U.S. Cl. CPC B01D 46/0005; B01D 45/08; B01D 46/2407; B01D 46/58; B01D 50/20; B01D 2265/022; B01D 2265/025; B01D 2265/026; B01D 2271/027

(57) ABSTRACT

A filter element for a separating element for separating liquid from a gaseous fluid has a filter medium body with an end disc with a fluid inlet opening. The end disc has a first part of a sealing device corresponding to a second part thereof arranged at an adapter of the separating element and has a first part of a bayonet connection device corresponding to a second part thereof arranged at the adapter. The separating element has a housing with housing bottom. The housing bottom has a fluid passage opening provided with the adapter. The filter element is received in the adapter. The fluid passage opening is in fluid connection with the fluid inlet opening of the filter element. The bayonet connection device surrounds the fluid passage opening and is accessible from an end face of the adapter. The separating element is arranged in a container of a separating device.

### CROSS-REFERENCE TO RELATED APPLICATIONS

This application is a continuation application of international application No. PCT/EP2024/082659 having an international filing date of Nov. 18, 2024, and designating the United States, the international application claiming a priority date of Nov. 24, 2023, based on prior filed German patent application No. 10 2023 132 841.7, the entire contents of the aforesaid applications being incorporated herein by reference to the fullest extent permissible.

### BACKGROUND

The invention concerns a filter element for a separating element for separating at least one liquid, wherein the liquid may be oil, fuel, hydraulic liquid or coolant, for example, from a gaseous fluid, for example from air, of a connection device, for example of a compressor, of a compressed air device, or of a vacuum pump. The invention concerns furthermore a separating element for a separating device for separating at least one liquid from a gaseous fluid and a separating device including the separating element.

Due to the increasing demand for large filter devices, the need for modularly constructed filter systems is also growing. A widely used possibility of forming such systems resides in the use of individual, usually elongate, tubularly constructed single filters in a common housing. One of the technical challenges resides in this context in the exchange of the single filters after reaching the service life, in combination with the safe function of the seal. Threads or bayonet connections are primarily used for attachment of the single filters.

DE 10 2015 215 168 B4 describes a filter with a generally cylindrical filter body which is arranged for use in a housing that includes a bottom plate for one or a plurality of filters. In this context, an inflow and relief are realized radially and another inflow and relief axially with the flow through the bottom plate. The filter includes a fixation means for attachment at the housing as well as a sealing means with a sealing region closer to the radial passage side and a sealing region more remote from the radial passage side, wherein the fixation means is arranged between the sealing means. The sealing region which is closer to the radial passage side surrounds the fixation means. In relation to the sealing region closer to the radial passage side, the sealing region which is more remote from the radial passage side is provided axially downwardly and radially inwardly displaced.

DE 10 2015 005 567 A1 discloses a filter system with at least one filter element for filtering a fluid, including a housing, and a closure device arranged at the housing. At the closure device, a first connection region for connecting the filter system to a second connection region of a counter element as well as a sealing region between filter element and the counter element are provided. In this context, the two connection regions may include a latch closure.

### SUMMARY

It is an object of the invention to provide a filter element for a separating element for separating at least one liquid from a gaseous fluid, which may be mounted quickly and safely in the separating element.

A further object is to provide a separating element for a separating device for separating at least one liquid from a gaseous fluid, which enables a fast and safe mounting of a filter element in the separating element.

A further object is to provide a separating device for separating at least one liquid from a gaseous fluid, which enables a fast and safe mounting of a filter element.

The aforementioned object is solved according to an aspect of the invention by a filter element for a separating element for separating at least one liquid from a gaseous fluid, including a hollow-cylindrical filter medium body which, at a first end face, includes an end disc with a fluid inlet opening, wherein the separating element includes at least one adapter for receiving the filter element, wherein the end disc includes a part of a sealing device, which is joinable in axial direction, which is configured to correspond to at least one other part of the sealing device at the at least one adapter, and wherein the end disc includes at least one part of a bayonet connection device which is configured to correspond to another part of the bayonet connection device at the at least one adapter.

The further object is solved according to a further aspect of the invention by a separating element for a separating device for separating at least one liquid from a gaseous fluid, including a housing and at least one filter element arranged therein, wherein a first end face of the housing includes a housing bottom with at least one fluid passage opening with an adapter and which is in fluid communication with a fluid inlet opening of the filter element, wherein the adapter includes a sleeve-shaped body, which surrounds an axis along an axial direction and which includes a part of a sealing device, which is joinable in axial direction, which is configured to correspond to another part of the sealing device at the filter element, and which includes at least one part of a bayonet connection device accessible via an end face of the sleeve-shaped body, which is configured to correspond to another part of the bayonet connection device at the filter element, wherein the bayonet connection device is arranged to surround the fluid passage opening at a radially outer side.

The further object is solved according to a further aspect of the invention by a separating device for separating at least one liquid from a gaseous fluid, including a container which includes at least one fluid inlet and one fluid outlet, including at least one separating element with a housing with at least one filter element arranged therein, wherein the separating element is arranged in the interior of the container and separates a raw side of the container from a clean side of the container.

Embodiments and advantages of the invention result from the following description, and the accompanying drawings.

According to one aspect of the invention, a filter element for a separating element for separating at least one liquid from a gaseous fluid is proposed, including a hollow-cylindrical filter medium body which at a first end face includes an end disc with a fluid inlet opening. The separating element includes at least one adapter for receiving the filter element. The end disc includes a part of a sealing device, which is joinable in axial direction, which is configured to correspond to another part of the sealing device at the at least one adapter. The end disc includes at least one part of a bayonet connection device which is configured to correspond to another part of the bayonet connection device at the at least one adapter.

Proposed is a filter element with a part of a closure system in order to be able to easily and safely mount the filter element in the separating element with an adapter. The adapter may be manufactured in a simple manner and ensures a simple mounting and demounting of the filter element. The closure system includes substantially a bayonet connection device and a matching sealing device. The bayonet connection device and the sealing device each include two parts which are complementary to each other, of which one part is arranged at the filter element and the other part at the adapter, respectively. The adapter is arranged at the housing of the separating element.

As a part of the bayonet connection device, a locking and guiding element which may be designed as a simple cam may be arranged at the filter element, for example. The counterpart at the adapter may be configured, for example, in the form of a wave-shaped ramp, a sliding block guide, and an end position.

The sealing device, for example, may include a seal seat and a seal, wherein the seal may be arranged at the filter element and the seal seat at the adapter.

The bayonet connection device and the sealing device may be axially spaced apart from each other. The part of the sealing device at the sleeve-shaped body of the adapter may be arranged, for example, at its radially inner side when guide surfaces are arranged at the sleeve-shaped body and cams at the filter element. When, in reverse, cams are arranged at the sleeve-shaped body and guide surfaces at the filter element, the part of the sealing device at the sleeve-shaped body of the adapter may be arranged, for example, at its radially outer side. As an alternative, a sealing device acting in axial direction may be provided.

In the closure system via the adapter, the two parts of the bayonet connection device are matched according to the lock-and-key principle. Also, in this way it is possible for the cooperation of the two parts to provide each with its own coding so that only appropriately coded filter elements may be mounted in the adapter of the separating element.

The filter element may then be mounted with a reliable function of the seal and demounted for exchange. Mounting and demounting of the filter element is possible even for a limited installation space. In comparison to the prior art, the sealing forces to be applied may be reduced.

A safe initial positioning of the filter element is possible. A faulty positioning of the filter element in the separating element is thereby prevented.

According to an embodiment of the filter element, a first part of the bayonet connection device may include at least one locking and guiding element which projects perpendicularly to an axial direction, for example, a cam or pin, which is configured for operative connection to the second part of the bayonet connection device at the at least one adapter. As an alternative, the first part of the bayonet connection device may include circumferential segments which include at their axial free ends guide surfaces extending along the circumferential direction which, beginning at a maximum, drop with a first section toward one side and with a second section toward the other side of the maximum along the circumferential direction and each end in an end position, of which the one of the first section is arranged in the same circumferential segment and the one of the second section in the neighboring circumferential section. In this way, a simple and easy mounting of the filter element at the adapter arranged at the separating element may be carried out. Faulty mounting of a filter element is thereby prevented.

The first and the second sections may include different inclines wherein the first section drops steeply. In this context, beginning at the maximum, the first section for example may pass at least in a rounded shape into the steep drop, for example substantially parallel to the axial direction. The first section may pass by an undercut into the end position of the same circumferential segment. For example, the undercut may include a linear incline in this context. The second section may pass with a gradual drop into the end position at the neighboring circumferential segment. The filter element may thus be guided in a reliable manner into a mounted position at the separating element and lock in the end position.

The first section of one circumferential segment at the end of the undercut before the end position and the second section of the neighboring circumferential segment may define a constriction. The filter element may thus be guided in a reliable manner into a mounted position at the separating element and lock in the end position.

According to a configuration of the filter element, the part of the sealing device may include a circumferential sealing ring, for example an O-ring, at the outer side of the end disc. As an alternative, the part of the sealing device may include a sealing surface at an inner side of the end disc corresponding to a sealing ring at the separating element. In this manner, a reliable sealing action of the filter element upon mounting in the adapter of the separating element may be achieved. In this way, a raw side may be reliably separated from a clean side by means of the filter element.

In an alternative embodiment, a sealing device acting in axial direction may be provided, for example, a sealing ring at the axial end face of the end disc of the filter element and a corresponding sealing surface at the separating element, for example at the housing bottom of the separating element. In an embodiment of a sealing device acting in axial direction, the separating element, for example the housing bottom of the separating element, may include a seal, for example in the form of a sealing ring, and the end disc of the filter element a corresponding sealing surface.

According to a further aspect of the invention, a separating element for a separating device for separating at least one liquid from a gaseous fluid is proposed, including a housing and at least one filter element arranged therein. In this context, a first end face of the housing includes a housing bottom including at least one fluid passage opening with an adapter which is in fluid communication with a fluid inlet opening of the filter element. The adapter includes a sleeve-shaped body which surrounds an axis along an axial direction and which includes a part of a sealing device, which is joinable in axial direction, which is configured to correspond to another part of the sealing device at the filter element. The sleeve-shaped body includes at least one part of a bayonet connection device accessible from an end face of the sleeve-shaped body, which is configured to correspond to another part of the bayonet connection device at the filter element. In this context, the bayonet connection device is arranged so as to surround the fluid passage opening at a radially outer side.

By means of the adapter arranged at the housing of the separating element around the at least one fluid passage opening, the at least one filter element may be mounted safely in the separating element.

The adapter is part of a closure system with which the at least one filter element may be mounted simply and safely in the separating element. The adapter may be produced easily and ensures a simple mounting and demounting of the filter element. The closure system includes substantially a bayonet connection device and a matching sealing device. The bayonet connection device and the sealing device each include two parts which are complementary to each other, of which one part, respectively, is arranged at the filter element and the other part at the adapter. The adapter is arranged at the housing of the separating element and is flowed through by the fluid which is filtered by the filter element. The filter element may be cylindrical and may include a filter medium body which is wound or folded around a hollow interior.

At the filter element, as part of the bayonet connection device, for example, a locking and guiding element may be arranged which may be configured as a simple cam or pin. The counterpart at the adapter may be configured, for example, in the form of a wavy ramp, a sliding block guide and an end position. As an alternative, the wavy ramp, sliding block guide and end position may be configured at the filter element and the locking and guiding element at the adapter. The parts of the bayonet connection will engage when filter element and adapter are joined in axial direction.

The sealing device, for example, may include a seal seat and a seal of which the seal may be arranged at the filter element and the seal seat at the adapter. As an alternative, the seal seat may be arranged at the filter element and the seal at the adapter. The parts of the sealing device reach the sealing position when filter element and adapter are joined in axial direction.

The bayonet connection device and the sealing device may be axially spaced apart from each other. The part of the sealing device at the sleeve-shaped body of the adapter may be arranged, for example, at its radially inner side when guide surfaces are arranged at the sleeve-shaped body and cams at the filter element. When, in reverse, cams are arranged at the sleeve-shaped body and guide surfaces at the filter element, the part of the sealing device at the sleeve-shaped body of the adapter may be arranged, for example, at its radially outer side.

In the proposed closure system via the adapter, the two parts of the bayonet connection device cooperate according to the lock-and-key principle. Also, in this way it is possible for the cooperation of the two parts to provide each with its own coding so that only appropriately coded filter elements may be mounted in the adapter of the separating element. In this way, filter elements for special applications and/or performances may be installed in a manner to prevent a mix-up.

With the proposed adapter filter elements may be mounted in a simple manner with a reliable function of the seal and demounted for exchange. Mounting and demounting of the filter elements is possible even for limited installation space. In comparison to the prior art, sealing forces to be applied may be reduced.

A safe initial positioning of the filter element is possible with the adapter even in case of filter elements with great axial length and relatively minimal diameter. Faulty positioning of filter elements in the separating element is thereby prevented.

The part of the sealing device at an inner side of the sleeve-shaped body may include a sealing surface corresponding to a sealing ring at the filter element. As an alternative, the part of the sealing device may include a sealing ring, for example an O-ring, at an outer side of the sleeve-shaped body. The sealing device, for example, may include a seal seat and a seal, of which the seal may be arranged at the filter element and the seal seat at the adapter, or vice versa.

The first part of the bayonet connection device may include circumferential segments of the sleeve-shaped body which include guide surfaces at their axial free end extending along the circumferential direction, which, beginning at a maximum, with a first section drop toward one side and with a second section drop toward the other side of the maximum along the circumferential direction and each pass into an end position, of which the one of the first section is arranged in the same circumferential segment and the one of the second section in the neighboring circumferential segment. As an alternative, the first part of the bayonet connection device may include at least one locking and guiding element which projects perpendicularly to the axial direction, for example, a cam or a pin, which is configured for operative connection to the second part of the bayonet connection device at the filter element. In this way, a simple and easy mounting of the filter element at the adapter arranged at the separating element may be performed. Faulty mounting of a filter element may thus be prevented.

The first and the second sections may include different inclines wherein the first section drops steeply. For example, in this context, beginning at the maximum, the first section for example may pass at least in a rounded shape into the steep drop. The first section may pass through an undercut into the end position of the same circumferential segment. For example, in this context the undercut may include a linear incline. The second section may pass with a gradual drop into the end position at the neighboring circumferential segment. The filter element in this way may be guided in a reliable manner into a mounted position at the separating element and lock in the end position. The steeply dropping section may drop about parallel to the axial direction.

The first section of one circumferential segment at the end of the undercut before the end position and the second section of the neighboring circumferential segment may define a constriction. The filter element may thus be guided in a reliable manner into a mounted position at the separating element and lock in the end position. The constriction may prevent that the locking and guiding element in operation of the filter element may be released from the end position due to vibrations or the like. In the end position a bulge in axial direction may be provided in which the locking and guiding element may become wedged in operation.

The sleeve-shaped body may include a plurality of circumferential segments, for example an uneven number of circumferential segments, for example three circumferential segments. In this manner, it may be ensured that the filter element may be mounted in the adapter without tilting in relation to the adapter and locks reliably in the end position. This is beneficial, for example, in case of long filter elements with relatively minimal diameter. The circumferential segments may also be arranged non-symmetrically in order to provide in this way a coding in the correlation between the adapter and the filter element.

The sleeve-shaped body may include a plurality of pins projecting in radial direction as part of the bayonet connection device. The filter element may be guided in a reliable manner into a mounted position at the separating element and lock in the end position even in such an alternative arrangement of the bayonet connection device.

In the closure system via the adapter, the two parts of the bayonet connection device are matched according to the lock-and-key principle. Also, in this way it is possible for the cooperation of the two parts to provide each with its own coding so that only appropriately coded filter elements may be mounted in the adapter of the separating element.

A reliable sealing action between a raw side and a clean side is provided by means of the filter element.

The filter element may thus be mounted easily with a reliable function of the seal and demounted for exchange. Mounting and demounting of the filter element is possible even in limited installation space. In comparison to the prior art, sealing forces to be applied may be reduced reliably.

A reliable initial positioning of the filter element is possible. A faulty positioning of the filter element in the separating element is thereby prevented.

According to an embodiment of the separating element, at the housing bottom a plurality of fluid passage openings may be arranged, each provided with an adapter for receiving a filter element. In this way, a high throughput of gaseous fluid through the separating element may be ensured.

For example, the plurality of fluid passage openings with adapters may be arranged at least partially on a circular arc. In this manner, a large number of filter elements may be arranged in the housing of the separating element.

For example, the number of fluid passage openings with adapters may include different spacings to their next neighbor fluid passage openings with adapters. A flexible arrangement of filter elements in the housing of the separating element is possible in this way.

According to an embodiment of the separating element, a second end face of the housing may be designed to be open. For example, the housing may be designed in a pot shape. With such a configuration, a simple mounting and demounting of the filter elements in the housing of the separating element may be carried out.

According to a configuration of the separating element, the adapter at the at least one fluid passage opening may be welded or screwed or press-fit in the housing bottom or formed as one piece together with the housing bottom. A reliable mounting with reliable sealing action between adapter and housing bottom may be achieved with various joining methods. The housing bottom may be suitably worked in order to configure the adapter in the housing bottom as an integral piece.

According to a further aspect of the invention, a separating device for separating at least one liquid from a gaseous fluid is proposed, including a container which includes at least one fluid inlet and one fluid outlet, including at least one separating element with a housing with at least one filter element arranged therein. In this context, the separating element is arranged in the interior of the container and separates a raw side of the container from a clean side of the container.

The proposed separating device is of a modular design since various separating elements with a different number of filter elements may be used in the one container of the separating device. Expediently, separating devices with different requirements may thus be produced inexpensively because carry over parts may be connected with a modular construction. Simple mounting and demounting of the filter element in the separating device may be ensured. Faulty positioning of filter elements as well as damages to the separating device is thereby reliably prevented.

The fluid inlet may be designed for a tangential inflow of the gaseous fluid against an inner wall surface of the container or for a non-tangential inflow of the gaseous fluid. A tangential inflow of the gaseous fluid enables a preseparation of liquid at the container wall so that the separating performance of the separating device may be significantly increased. As an alternative, also other angles of inflow may be realized in the container.

According to a configuration of the separating device, the container may include a container opening in which the housing of the separating element is inserted. In this context, a second open end face of the housing of the separating element is seal-tightly closed by a container cover. The fluid outlet is arranged in the container cover. In this manner, the container cover may serve as a common cover of the housing of the separating element as well as of the container. The purified fluid may thus be efficiently discharged through the container cover.

According to a configuration of the separating device, a housing wall of the housing of the separating element may be formed as one piece together with the wall of the container. In this context, the housing bottom separates the raw side of the container from the clean side of the container. In this manner, an additional housing for the separating element may be avoided because the filter elements may be mounted directly on the housing bottom which is fixedly connected to the container and which separates in the interior of the container the raw side from the clean side. The housing bottom in this context may also serve as a reinforcement of the container.

### BRIEF DESCRIPTION OF THE DRAWINGS

Further advantages result from the following drawing description. In the drawings, embodiments of the invention are illustrated. The drawings, the description and the appended claims contain numerous features in combination. A person of skill in the art will consider the features expediently also individually and combine them to expedient further combinations.

FIG. 1 shows an isometric view of a separating device for separating at least one liquid from a gaseous fluid according to an embodiment of the invention.

FIG. 2 shows a longitudinal section through the separating device according to FIG. 1.

FIG. 3 shows a detail of the longitudinal section according to FIG. 2 with a separating element for separating at least one liquid from a gaseous fluid according to an embodiment of the invention.

FIG. 4 shows an isometric illustration of a separating element according to an embodiment of the invention.

FIG. 5 shows a partially sectioned isometric illustration of the separating element according to FIG. 4.

FIG. 6 shows a partially sectioned isometric illustration of the housing of the separating element according to FIG. 4.

FIG. 7 shows an isometric illustration of a filter element for separating at least one liquid from a gaseous fluid according to an embodiment of the invention.

FIG. 8 shows an isometric illustration of an adapter for mounting a filter element in a separating element according to an embodiment of the invention.

FIG. 9 shows a detail of a longitudinal section through the filter element according to FIG. 7.

FIG. 10 shows a side view of a filter element upon insertion into an adapter.

FIG. 11 shows a longitudinal section through the filter element upon insertion into the adapter according to FIG. 10.

FIG. 12 shows a side view at the beginning of the mounting process of the filter element inserted into the adapter.

FIG. 13 shows a longitudinal section through the filter element inserted into the adapter according to FIG. 12.

FIG. 14 shows a side view of the filter element inserted into the adapter in a further mounting state.

FIG. 15 shows a longitudinal section through the filter element inserted into the adapter according to FIG. 14.

FIG. 16 shows a side view of the filter element mounted in the adapter.

FIG. 17 shows a longitudinal section through the filter element mounted in the adapter according to FIG. 16.

FIG. 18 shows a longitudinal section through a separating device according to a further embodiment of the invention.

FIG. 19 shows a detail of the longitudinal section according to FIG. 18 with the separating element embodied in the container of the separating device.

### DETAILED DESCRIPTION

In the drawing figures, same or same-type components are identified with the same or similar reference characters. The drawing figures show only examples and are not to be understood as limiting.

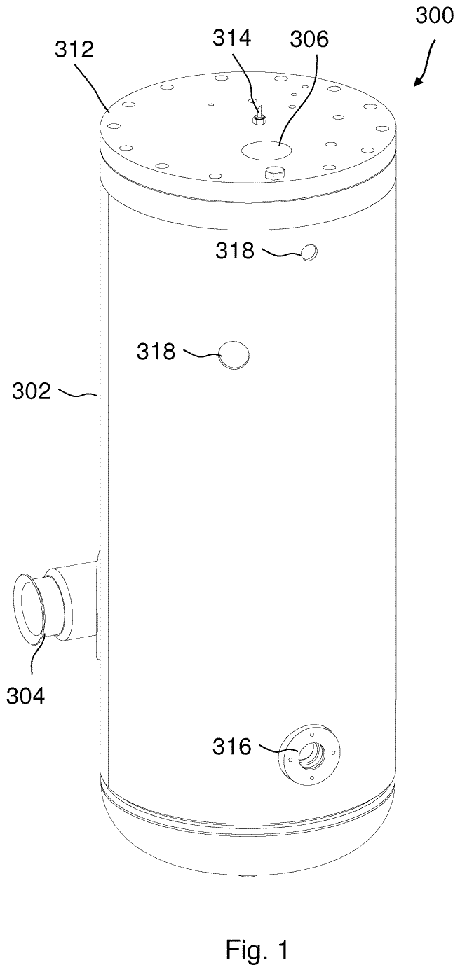

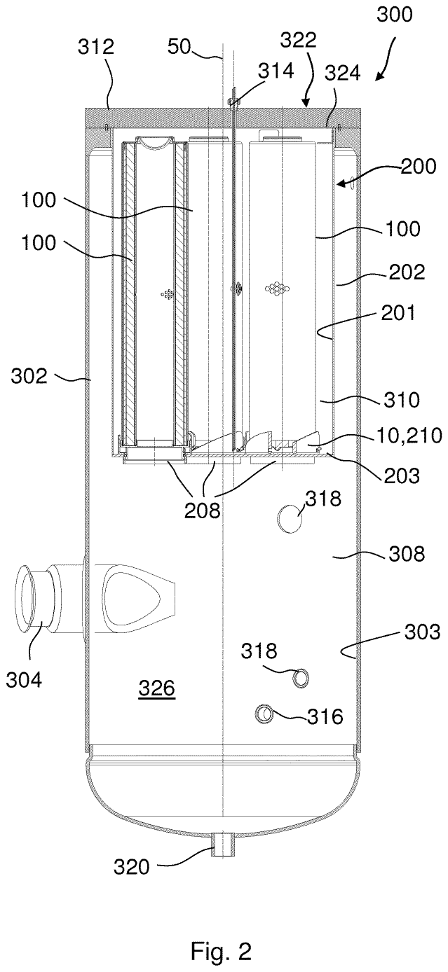

FIG. 1 shows an isometric view of a separating device 300 for separating at least one liquid from a gaseous fluid according to an embodiment of the invention, while in FIG. 2 a longitudinal section through the separating device 300 is illustrated.

The separating device 300 comprises a container 302 which comprises a fluid inlet 304 and a fluid outlet 306. The container 302 is closed by a container cover 312.

In this embodiment, the fluid inlet 304 is configured, for example, for tangential inflow of the gaseous fluid against an inner wall surface 303 of the container 302 in order to achieve a preseparation of the liquid, for example, oil, at the wall surface 303. The separated liquid may be drained through a fluid outlet 320 at the bottom of the container 302.

The separating device 300 comprises a separating element 200 with a housing 202 with a plurality of filter elements 100 arranged therein. The separating element 200 is arranged in the interior 326 of the container 302 and separates a raw side 308 of the container 302 from a clean side 310.

The container 302 comprises at an end face 322 a container opening 324 in which the housing 202 of the separating element 200 is inserted. A second open end face 206 of the housing 202 of the separating element 200 is seal-tightly closed by the container cover 312. The fluid outlet 306 of the separating element 200 is arranged in the container cover 312.

In addition, the container 302 comprises at its outer side various passages 318, for example, for sensors, as well as a viewing port 316 by means of which the interior 326 of the container 302 may be inspected from the exterior at least partially.

In the container cover 312, a suction device 314 is furthermore arranged by means of which liquid, separated in the interior of the housing 202 by the separating element 200 and collected at the housing bottom 203, may be removed by suction.

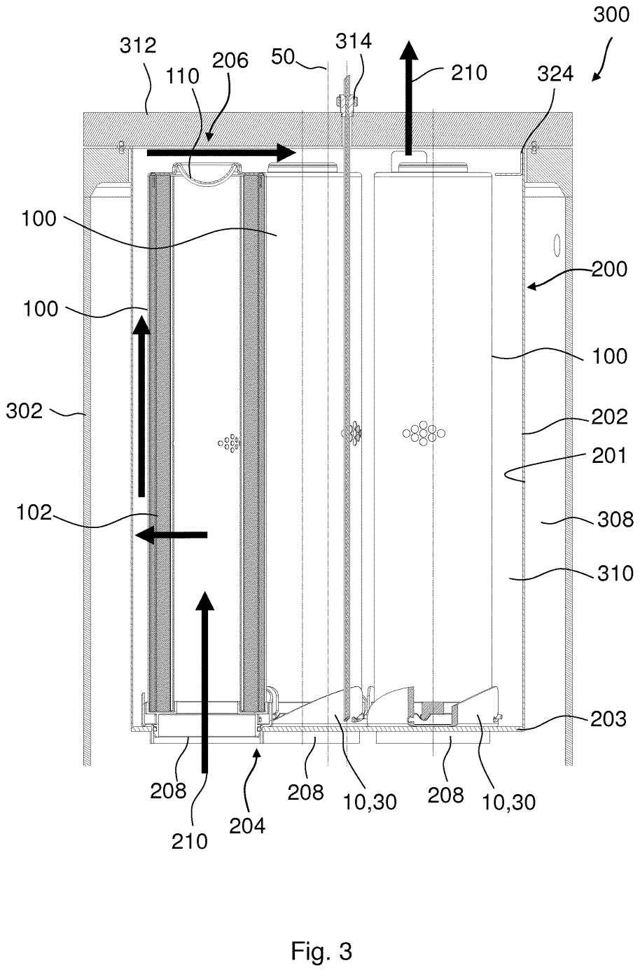

FIG. 3 shows a detail of the longitudinal section according to FIG. 2 with the separating element 200. In this context, one of the filter elements 100 is illustrated in section. Arrows indicate in an exemplary fashion the fluid flow 210. The fluid to be filtered enters from below through the fluid inlet opening 108 into the interior of the filter element 100, more precisely the interior of the filter medium body 102. The filter medium body 102 is closed at the side opposite the fluid inlet opening 108 by a cover 110. The fluid passes through the filter medium body 102 radially to the exterior. In doing so, liquid is separated from the fluid and runs downwardly at the exterior of the filter medium body 102 inside the housing 202 of the separating element 200 where it collects at the housing bottom 203. From there, it may be removed by suction by means of the suction device 314.

In an alternative embodiment, it is possible that the fluid to be filtered passes through the filter medium body 102 from the radially outer side into the interior of the filter element 100. In this case, the arrows of the fluid flow 210 would point in the opposite directions, respectively.

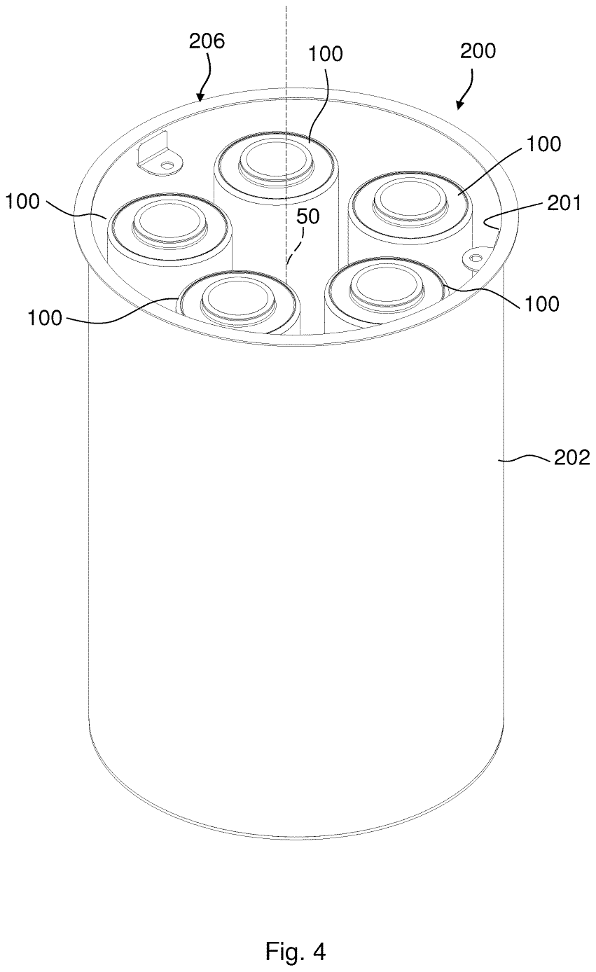

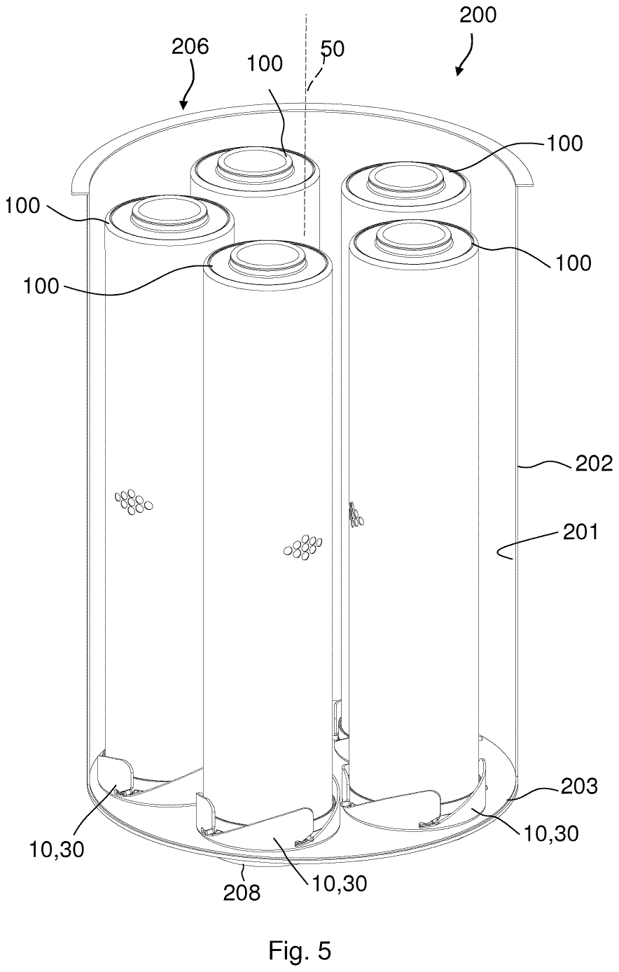

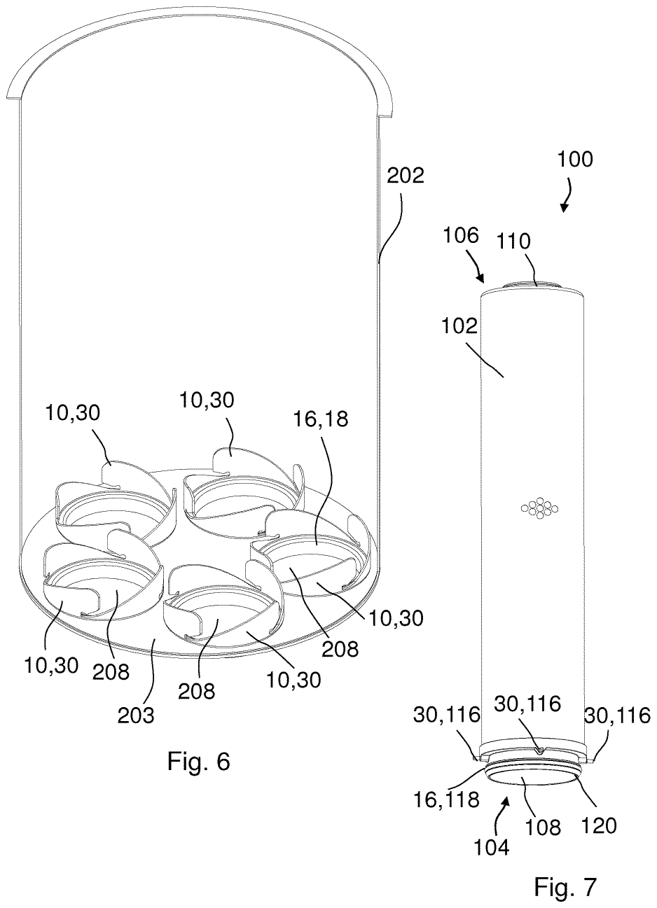

In FIG. 4, an isometric illustration of a separating element 200 according to an embodiment of the invention may be seen, while in FIG. 5 a partially sectioned isometric illustration of the separating element 200 according to FIG. 4 is illustrated. FIG. 6 shows a partially sectioned isometric illustration of the housing 202 of the separating element 200 according to FIG. 4. In FIG. 7, an isometric illustration of a filter element 100 for separating at least one liquid from a gaseous fluid in accordance with an embodiment of the invention may be seen.

The separating element 200 of the separating device 300 serves for separating at least one liquid from a gaseous fluid, for example, for separating oil from air. The separating element 200 comprises a pot-shaped housing 202, for example, and a plurality of cylindrical filter elements 100 arranged therein which are immersed completely in the housing 202. Such cylindrical filter elements 100 with large axial length and relatively small diameter are also known as filter candles.

A first end face 204 of the housing 202 comprises a housing bottom 203 with a plurality of fluid passage openings 208 which each comprise an adapter 10 for receiving the filter elements 100, as may be seen for example in FIGS. 5 and 6. The fluid passage openings 208 with adapters 10 are arranged on a circular arc in order to achieve a dense packing of filter elements 100 in the housing 202. At the fluid passage openings 208, the adapters 10 may be welded or screwed or press-fit in the housing bottom 203, for example. The adapters 10 are flowed through by the gaseous fluid.

The housing 202 is of a pot-shaped configuration wherein the second end face 206 of the housing 202 is configured to be open and, in the mounted state in the container 302 of the separating device 300, is closed by the container cover 312.

The fluid passage openings 208 are in fluid connection with the fluid inlet openings 108 of the filter elements 100 mounted in the housing 202.

As may be seen for example in FIG. 6, the adapters 10 arranged at the fluid passage openings 208 comprise at least one part of a bayonet connection device 30 which is configured to correspond to another part of the bayonet connection device 30 at the filter element 100. The bayonet connection device 30 surrounds in this context the fluid passage opening 208 at a radially outer side.

Further, as part of the adapter 10, the fluid passage openings 208 comprise a part, namely a sealing surface 18, of a sealing device 16, which is joinable in axial direction 50, which is configured to correspond to another part of the sealing device 16 at the filter element 100.

The filter element 100 illustrated in FIG. 7 comprises a hollow cylindrical filter medium body 102 which comprises an end disc 120 with a fluid inlet opening 108 at a first end face 104. The second end face 106 is closed fluid-tightly by a cover 110.

The end disc 120 comprises a part, namely a sealing ring 118, of a sealing device 16, which is joinable in an axial direction 50, which is configured to correspond to the other part of the sealing device 16, namely the sealing surface 18, at the adapter 10. The end disc 120 comprises furthermore a part of a bayonet connection device 30, namely locking and guiding elements 116 in the form of, for example, cams or pins, which are configured to correspond to another part of the bayonet connection device 30 at the adapter 10.

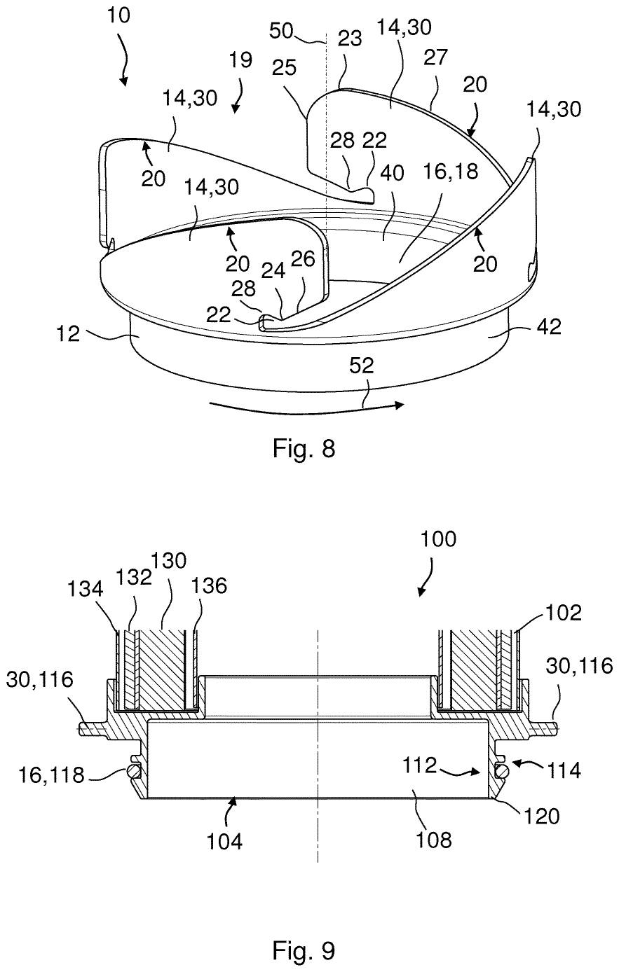

FIG. 8 shows an isometric illustration of the adapter 10 for mounting the filter element 100 in the separating element 200, while in FIG. 9 a detail of the longitudinal section through the filter element 100 according to FIG. 7 is illustrated.

The adapter 10 comprises a sleeve-shaped body 12 surrounding an axis along an axial direction 50. The sleeve-shaped body 12 comprises a part of the sealing device 16, which is joinable in axial direction 50, which is configured to correspond to the other part of the sealing device 16 at the filter element 100.

The sleeve-shaped body 12 comprises furthermore a part of the bayonet connection device 30, which is accessible from the end face 19 of the sleeve-shaped body 12, which is configured to correspond to the other part of the bayonet connection device 30 at the filter element 100.

The bayonet connection device 30 and the sealing device 16 are axially spaced apart from each other.

The part of the sealing device 16 at the sleeve-shaped body 12 is arranged at its side 40 arranged inwardly in radial direction and comprises a sealing surface 18 corresponding to a sealing ring 118 at the filter element 100. The side 42 arranged outwardly in radial direction does not form a sealing surface or seal seat in this embodiment.

The part of the bayonet connection device 30 at the adapter 10 comprises circumferential segments 14 of the sleeve-shaped body 12 which, at their axial free ends, comprise guide surfaces 20 extending along the circumferential direction 52 which, beginning at a maximum 23 present in axial direction 50, drop with a first section 25 toward one side and with a second section 27 toward the other side of the maximum 23 along the circumferential direction 52 and each end in an end position 22. The end position 22 of the first section 25 is arranged in the same circumferential segment 14 and that one of the second section 27 in the neighboring circumferential segment 14.

The first and the second sections 25, 27 have different inclines. In this context, the first section 25 drops steeply, almost parallel to the axial direction 50. For example, beginning at the maximum 23, the first section 25 passes at least in a rounded shape into the steep drop in this context. The first section 25 passes through an undercut 26 into the end position 22 of the same circumferential segment 14. The undercut 26 comprises in this context a linear incline. The second section 27, on the other hand, passes with a gradual drop into the end position 22 at the neighboring circumferential segment 14.

Furthermore, the first section 25 of one circumferential segment 14 at the end of the undercut 26 before the end position 22 and the second section 27 of the neighboring circumferential segment 14 define a constriction 24. Behind the constriction 24, the end position 22 has a bulge 28 in axial direction 50.

The sleeve-shaped body 12 may comprise a plurality of circumferential segments 14, for example an uneven number of circumferential segments 14, for example three circumferential segments 14. In this way, a simple and tilting-resistant mounting of the filter element 100 is thereby ensured.

In the filter element 100 illustrated in FIG. 9, one part of the bayonet connection device 30 comprises locking and guiding elements 116 projecting perpendicularly to an axial direction 50 and configured for an operative connection to the other part of the bayonet connection device 30 at the adapter 10. The part of the sealing device 16 comprises a sealing ring 118, for example an O-ring, circumferentially extending at the outer side 114 of the end disc 120.

When mounting the filter element 100 in the adapter 10 of the separating element 200, the locking and guiding elements 116 of the filter element 100 glide along the guide surface 20 of the circumferential segment 14, either in the first section 25 or in the second section 27, and reach thus safely the entry of the undercut 26 acting as a slotted guide.

By rotating the filter element 100 in clockwise direction, the locking and guiding element 116 now follows the undercut 26 and enables in this way, with minimal force expenditure by the operator, to safely reach the sealing surface 18 with the radial sealing ring 118. In case of axial sealing, the application of the required axial sealing force may thus be ensured.

When reaching the end position 22 after having overcome the constriction 24 with the locking and guiding element 116, a locking action occurs which, for example, may be accompanied by a clear clicking noise as an acoustic feedback for a safe assembly.

The end position 22 is designed such that the filter element 100 is pushed into the end position 22 and thus opening under pressure is not possible during the operation.

For demounting, the filter element 100 is pushed downwardly and subsequently rotated counter to the clockwise direction. In this way, the filter element 100 is unlocked from the end position(s) 22. The locking and guiding element 116 glides along the undercut 26, separates the sealing ring 118 from the seal seat 18 and, subsequently, may be pulled off in axial direction 50.

The mounting process is described based on the example of a locking and guiding element 116 in the form of a pin. In the example illustrated in the drawing figures, four such locking and guiding elements 116 embodied as pins follow the corresponding guiding surfaces 20 of the circumferential segments 14.

In an alternative embodiment, the part of the bayonet connection device 30 at the filter element 100 may comprise correspondingly configured circumferential segments 14 with guide surfaces 20, while the other part of the bayonet connection device 30 at the sleeve-shaped body 12 of the adapter 10 comprises a plurality of locking and guiding elements 116 projecting in radial direction, for example, pins or cams, as part of the bayonet connection device 30.

In a further alternative embodiment, the part of the sealing device 16 of the filter element 100 at the inner side 112 of the end disc 120 may comprise a sealing surface 18 corresponding to a sealing ring 118 at the adapter 10 of the separating element 200 as the other part of the sealing device 16.

In FIG. 9, furthermore the configuration of the filter medium body 102 may be seen in an exemplary fashion. The filter medium body 102 in the illustrated embodiment comprises substantially a main separator 130 as well as an auxiliary separator 132, surrounding it at the radially outer side. Main separator 130 and/or auxiliary separator 132 may be configured, for example, as a nonwoven. At the radially outer side and the radially inner side, the filter medium body 102 comprises a cover 134, 136, respectively, for example, a wire net, as a hand guard and/or support.

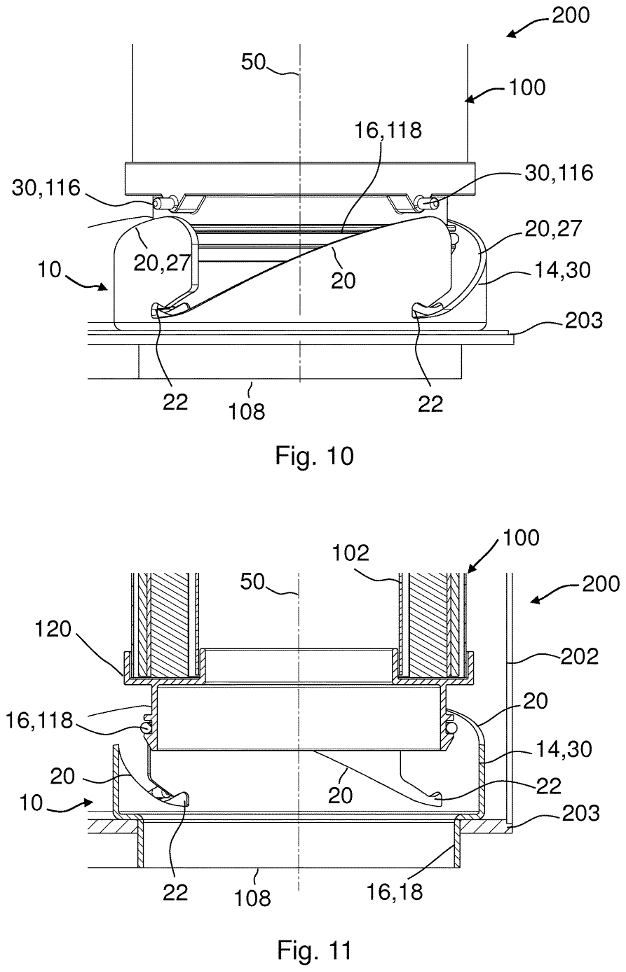

FIG. 10 shows a side view of a filter element 100 upon insertion into an adapter 10 while in FIG. 11 a longitudinal section through the filter element 100 upon insertion into the adapter 10 is illustrated. In this context, the locking and guiding elements 116, for example, pins, of the bayonet connection device 30 at the end disc 120 of the filter element 100 are still above the guide surfaces 20 of the circumferential segment 14 of the sleeve-shaped body 12 of the adapter 10. The two parts of the bayonet connection device 30, similarly the two parts of the sealing device 16, are not yet engaged.

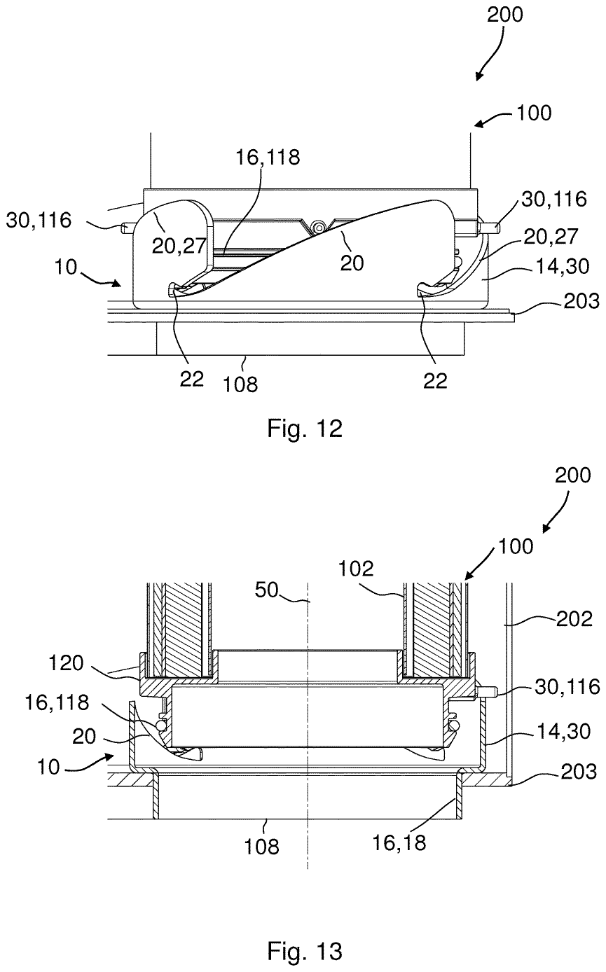

FIG. 12 shows a side view at the beginning of the mounting process of the filter element 100 inserted into the adapter 10, while FIG. 13 shows a longitudinal section through the filter element 100 inserted into the adapter 10. The filter element 100 has been lowered onto the adapter 10 in axial direction 50. In this context, the locking and guiding elements 116 embodied as pins glide along the second section 27 of the guide surface 20. The parts of the sealing device 16 are not yet engaged.

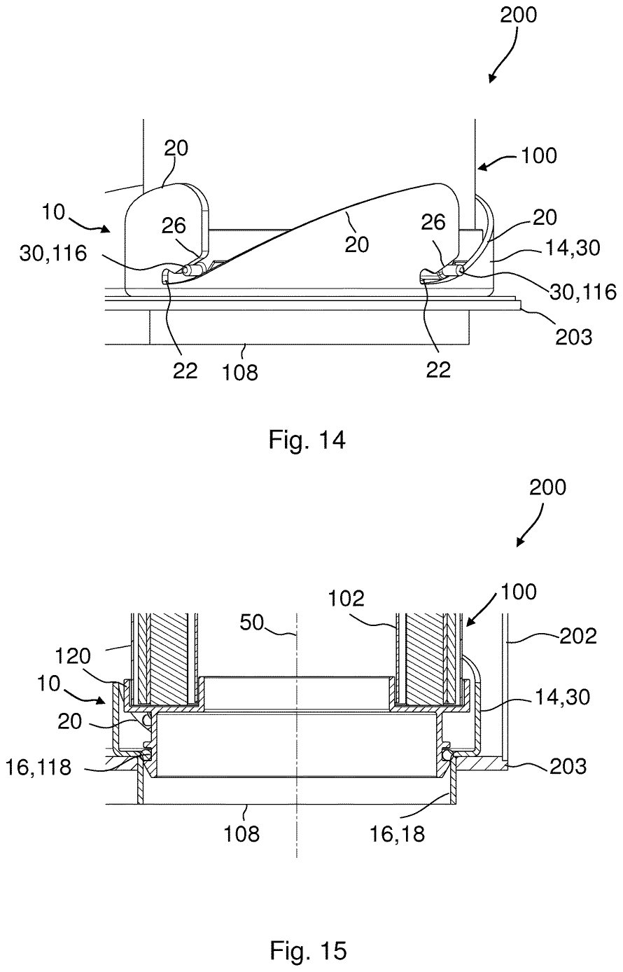

FIG. 14 shows a side view of the filter element 100 inserted in the adapter 10 in a further mounting state, while in FIG. 15 a longitudinal section through the filter element 100 inserted in the adapter 10 according to FIG. 14 is illustrated. The filter element 100 has been rotated farther in clockwise direction so that the locking and guiding elements 116 embodied as pins have reached the slotted guide of the undercut 26. The sealing ring 118 of the filter element 100 is positioned at the upper end of the sealing surface 18.

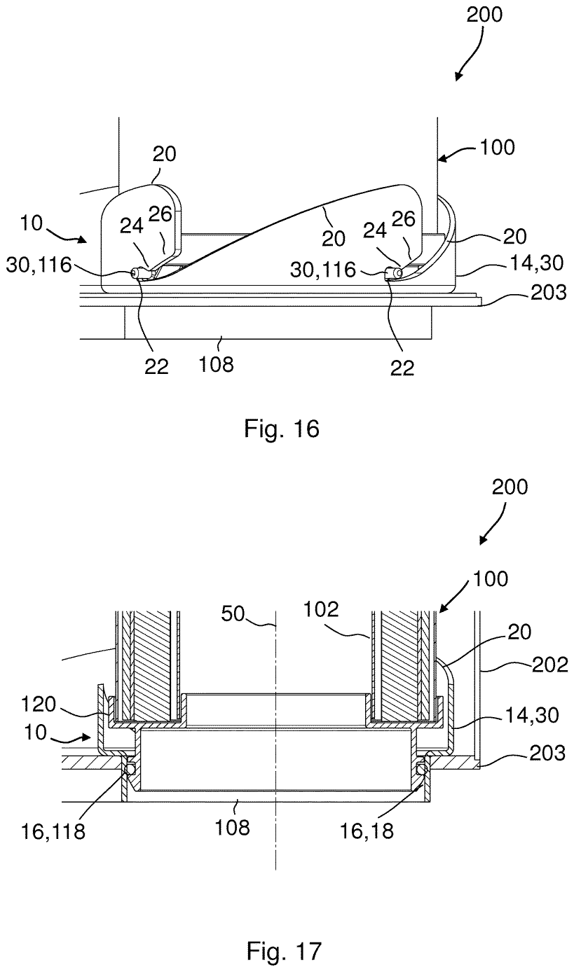

FIG. 16 shows a side view of the filter element 100 mounted in the adapter 10, while in FIG. 17 a longitudinal section through the filter element 100 mounted in the adapter 10 is illustrated. The locking and guiding elements 116 embodied as pins have reached the end position 22 after overcoming the constriction 24 in the slotted guide of the undercut 26. The sealing ring 118 of the filter element 100 rests completely at the sealing surface 18 so that a reliable sealing action between the raw side 308 and the clean side 310 is achieved.

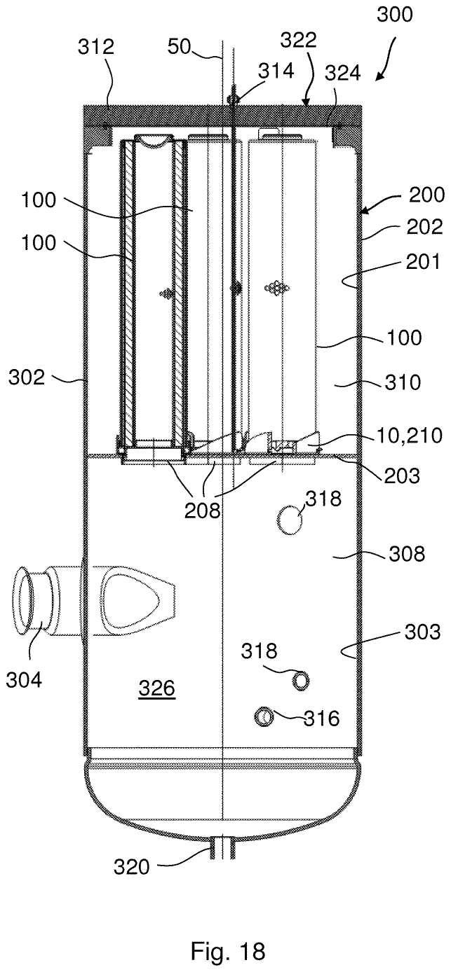

In FIG. 18, a longitudinal section through a separating device 300 according to a further embodiment of the invention is illustrated.

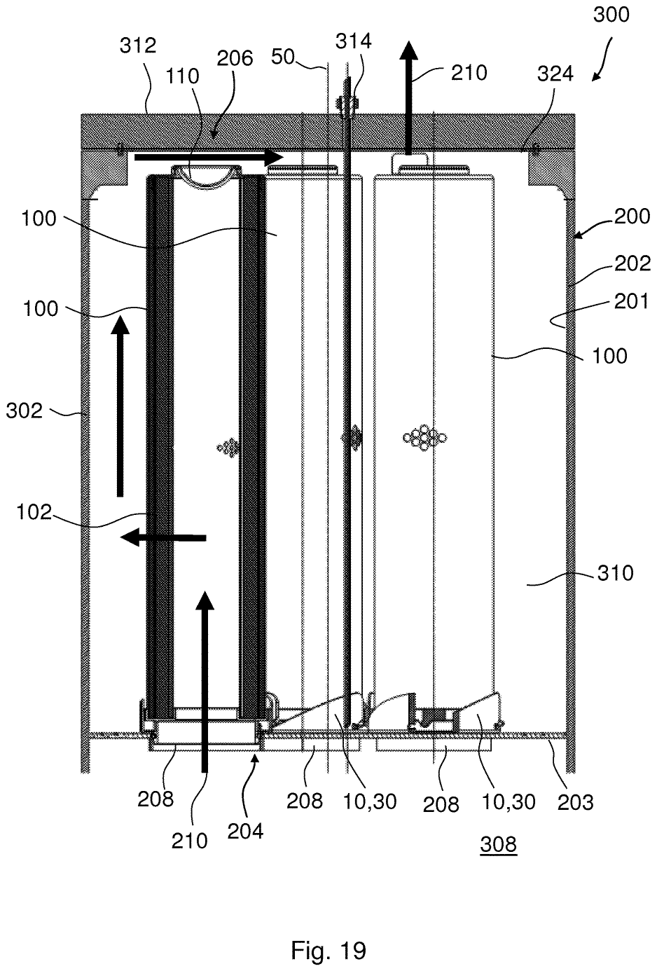

In this context, the separating element 200 is formed directly in the container 302 of the separating device 300. In FIG. 19, an enlarged detail in this regard is illustrated.

In this embodiment, an additional housing 202 is omitted because the housing wall 201 of the housing 202 of the separating element 200 is formed as one piece together with the wall 303 of the container 302 of the separating device 300. The housing bottom 203 with the adapters 10 for mounting the filter elements 100 is arranged directly in the container 302 and separates there the raw side 308 of the container 302 from the clean side 310 of the container 302.

### REFERENCE CHARACTERS

10 adapter
12 sleeve-shaped body
14 circumferential segment
16 sealing device
18 sealing surface
19 end face
20 guide surface
22 end position
23 maximum
24 constriction
25 first section
26 undercut
27 second section
28 bulge
30 bayonet connection device
40 inner side
42 outer side
50 axial direction
52 circumferential direction
100 filter element
102 filter medium body
104 first end face
106 second end face
108 fluid inlet opening
110 cover
112 inner side
114 outer side
116 locking and guiding element
118 seal
120 end disc
130 main separator
132 auxiliary separator
134 cover
136 cover
200 separating element
201 housing wall
202 housing
203 housing bottom
204 first end face
206 second end face
208 fluid passage opening
210 fluid flow direction
300 separating device
302 container
303 wall
304 gas inlet
306 gas outlet
308 raw side
310 clean side
312 container cover
314 suction device
316 viewing port
318 sensor passage
320 fluid outlet
322 end face
324 container opening
326 interior

That which is claimed is:

1. A filter element for a separating element for separating at least one liquid from a gaseous fluid, wherein the separating element comprises an adapter for receiving the filter element, the filter element comprising:
a filter medium body comprising an end disc with a fluid inlet opening at an end face of the filter medium body;
wherein the end disc comprises a first part of a sealing device, wherein the first part of the sealing device is configured to correspond to a second part of the sealing device arranged at the adapter of the separating element, wherein the first part of the sealing device and the second part of the sealing device are configured to be joined;
wherein the end disc further comprises a first part of a bayonet connection device, wherein the first part of the bayonet connection device is configured to be joined to a second part of the bayonet connection device arranged at the adapter.

2. The filter element according to claim 1, wherein:
the first part of the bayonet connection device comprises at least one locking and guiding element projecting perpendicularly to an axial direction, and wherein the at least one locking and guiding element is configured to operatively connect to the second part of the bayonet connection device arranged at the adapter,
or
the first part of the bayonet connection device comprises circumferential segments, wherein the circumferential segments each comprise a guide surface arranged at a free axial end of the respective circumferential segment and extending along a circumferential direction, wherein the guide surface, beginning at a maximum, drops along the circumferential direction with a first section toward a first side of the maximum and with a second section toward a second side of the maximum, wherein the first section and the second section each end in an end position, and wherein the end position of the first section is arranged in the respective circumferential segment and the end position of the second section is arranged in a circumferential segment neighboring the respective circumferential segment.

3. The filter element according to claim 1, wherein:
the first part of the sealing device comprises a sealing ring circumferentially extending at an outer side of the end disc,
or
the first part of the sealing device comprises a sealing surface arranged at an inner side of the end disc and configured to correspond to a sealing ring arranged at the adapter of the separating element.

4. A separating element for a separating device for separating at least one liquid from a gaseous fluid, the separating element comprising:
a housing;
at least one filter element arranged in the housing, wherein the at least one filter element comprises a filter medium body comprising an end disc with a fluid inlet opening at an end face of the filter medium body, wherein the end disc comprises a first part of a sealing device and further comprises a first part of a bayonet connection device;
wherein the housing comprises a housing bottom at a first end face of the housing, wherein the housing bottom comprises at least one fluid passage opening comprising an adapter, wherein the at least one filter element is received in the adapter and the at least one fluid passage opening is in fluid connection with the fluid inlet opening of the at least one filter element;
wherein the adapter comprises a sleeve-shaped body surrounding an axis along an axial direction, wherein the sleeve-shaped body comprises a second part of the sealing device and further comprises a second part of the bayonet connection device;
wherein the first part of the sealing device is configured to correspond to the second part of the sealing device and the sealing device is configured to be joined in the axial direction;
wherein the first part of the bayonet connection device is configured to correspond to the second part of the bayonet connection device;
wherein the bayonet connection device surrounds the fluid passage opening at a radially outer side thereof and is accessible from an end face of the sleeve-shaped body of the adapter.

5. The separating element according to claim 4, wherein a plurality of the at least one fluid passage opening are arranged at the housing bottom.

6. The separating element according to claim 5, wherein the plurality of the at least one fluid passage opening are arranged at least partially on a circular arc.

7. The separating element according to claim 4, wherein a second end face of the housing is an open end face.

8. The separating element according to claim 7, wherein the housing has a pot-shaped configuration.

9. The separating element according to claim 4, wherein the adapter is welded or screwed or press-fit in the housing bottom.

10. The separating element according to claim 4, wherein the adapter is formed as one piece together with the housing bottom.

11. A separating device for separating at least one liquid from a gaseous fluid, the separating device comprising:
a container comprising a fluid inlet and a fluid outlet,
at least one separating element according to claim 4, wherein the separating element is arranged in an interior of the container and separates a raw side of the container from a clean side of the container.

12. The separating device according to claim 11, wherein the container comprises a container opening and further comprises a container cover, wherein the housing of the at least one separating element is inserted in the container opening, wherein the housing of the at least one separating element comprises a second open end face, wherein the container cover covers and seal-tightly closes the second open end face of the housing of the at least one separating element, and wherein the fluid outlet of the container is arranged in the container cover.

13. The separating device according to claim 11, wherein a housing wall of the housing of the at least one separating element is formed as one piece together with a wall of the container, and wherein the housing bottom of the at least one separating element separates the raw side of the container from the clean side of the container.

14. The separating element according to claim 4, wherein:
the first part of the bayonet connection device comprises at least one locking and guiding element projecting perpendicularly to an axial direction, and wherein the at least one locking and guiding element is configured to operatively connect to the second part of the bayonet connection device arranged at the adapter,
or
the first part of the bayonet connection device comprises circumferential segments, wherein the circumferential segments each comprise a guide surface arranged at a free axial end of the respective circumferential segment and extending along a circumferential direction, wherein the guide surface, beginning at a maximum, drops along the circumferential direction with a first section toward a first side of the maximum and with a second section toward a second side of the maximum, wherein the first section and the second section each end in an end position, and wherein the end position of the first section is arranged in the respective circumferential segment and the end position of the second section is arranged in a circumferential segment neighboring the respective circumferential segment.

15. The separating element according to claim 4, wherein:
the first part of the sealing device comprises a sealing ring circumferentially extending at an outer side of the end disc,
or
the first part of the sealing device comprises a sealing surface arranged at an inner side of the end disc and configured to correspond to a sealing ring arranged at the adapter of the separating element.
